(19) United States
(12) Patent Application Publication
(10) Pub. No.: US 2015/0292668 A1
(43) Pub. Date: Oct. 15, 2015

(54) COATING SYSTEM FOR COATED METAL OR POLYMERIC TUBE

(71) Applicant: Lenar ABBASOV, Wixom, MI (US)

(72) Inventors: Lenar Abbasov, West Bloomfield, MI (US); Andrew Sics, White Lake, MI (US); Sarah Elizabeth Grieshaber, Newburgh, IN (US); Scott Michael Davis, Pittsfield, MA (US); Tianhua Ding, Newburgh, IN (US)

(73) Assignee: SABIC Global Technologies B.V., Bergen op Zoom (NL)

(21) Appl. No.: 14/441,207

(22) PCT Filed: Dec. 3, 2013
(86) PCT No.: PCT/US2013/072862

§ 371 Date: May 7, 2015

Related U.S. Application Data
(60) Provisional application No. 61/735,851, filed on Dec. 11, 2012.
(60) Provisional application No. 61/733,112, filed on Dec. 4, 2012.

(51) Int. Cl. F16L 58/10; B05D 7/14; B05D 7/22; F16L 58/12

(52) U.S. Cl. CPC F16L 58/1054; F16L 58/12; F16L 58/10; B05D 7/146; B05D 7/222

(57) ABSTRACT

A coated tube can comprise: a tube and a coating composition on the tube. The coating composition can comprise a polyester and an impact modifier, and wherein the impact modifier comprises at least one pendent group selected from epoxy groups and maleic anhydride groups and/or a polyester and an impact modifier, and wherein the polyester comprises poly(butylene terephthalate).

### CROSS-REFERENCE TO RELATED APPLICATION

This application claims the benefit of U.S. Provisional Patent Application Ser. No. 61/733,112 filed Dec. 4, 2012 and U.S. Provisional Patent Application Ser. No. 61/735,851 filed Dec. 11, 2012. The related application is incorporated herein by reference.

### BACKGROUND

Tubing in automotive applications is generally located on the underside of the automobile where they are exposed to harsh environments. For example, such tubing can be consistently exposed to abrading forces, such as those arising from rocks hitting the tubing; corrosion forces, such as those arising from exposure to salt that is used to prevent water from freezing on the roads; and vibrational forces, such as those arising from the movement of the automobile. Likewise, flexible fuel vehicles (FFVs) often are designed to be fueled by methanol, ethanol, gasoline, and/or any combination of these fuels. Certain fuel blends can corrosively attack metals, even some types of stainless steel.

Emissions standards, for example, those issued by the California Air Resources Board (CARB) and the U.S. EPA, have been increasing their standards and have mandated no leakage or permeation for as high as 150,000 miles or 15 years. In order to meet the standards and address the damaging forces, automotive tubing has been covered with one or more layers of a protective coating. Materials that have been used as protective coatings have exhibited only limited resistance to the above mentioned destructive forces.

Furthermore, tubing for automotive applications often requires fabrication processes such as bending, pressing, or punching after the tubing has been coated. Since these processes results in severe action on the coatings, unlike for example in the case of bending of a wire, coated tubes generally have poor workability. For example, when a metal tube coated with polyethylene or poly(vinyl chloride) is subjected to bending, pressing, or punching, the coating can be detached from the metal surface, creased, or cracked.

A protective coating that exhibits one or more of improved abrasion resistance, corrosion resistance, and vibration resistance that forms a good adhesive bond with either the tubing directly or an adhesive layer would be desirable. A protective coating that further has an improved adhesion to a metal tube and results in a reduction of one or more of peeling, creasing, and cracking during metal forming processes is further desirable.

### BRIEF DESCRIPTION

Disclosed herein are coated tubes, methods for making coated tubes, and methods of using coated tubes.

In an embodiment, a coated tube can comprise: a tube; and a coating composition on the tube. The coating composition can comprise a polyester and an impact modifier, and wherein the impact modifier comprises at least one pendent group selected from epoxy groups and maleic anhydride groups.

In another embodiment, a coated tube can comprise: a tube; and a coating composition on the tube. The coating composition can comprise a polyester and an impact modifier, and wherein the polyester comprises poly(butylene terephthalate).

In an embodiment, a method of coating a tube can comprise: applying a coating composition to a tube. The coating composition can comprise a polyester and an impact modifier, and wherein the impact modifier comprises at least one pendent group selected from epoxy groups and maleic anhydride groups; or a polyester and an impact modifier, and wherein the polyester comprises poly(butylene terephthalate); or a polyester and an impact modifier, and wherein the polyester comprises poly(butylene terephthalate) and the impact modifier comprises at least one pendent group selected from epoxy groups and maleic anhydride groups.

The above described and other features are exemplified by the following figures and detailed description.

### BRIEF DESCRIPTION OF THE DRAWINGS

Refer now to the figures, which are exemplary embodiments:

FIG. 1 is a graphical representation of the percent elongation of Example 1 after exposure to various solvents;

FIG. 2 is a graphical representation of the percent elongation of Example 2 after exposure to various solvents at 23° C. for 500 h;

FIG. 3 is a graphical representation of the percent elongation of Example 2 after exposure to various solvents at 60° C. for 1,000 h;

FIG. 4 is a graphical representation of the percent elongation of Example 2 after exposure to various solvents at 60° C. for 5,000 h; and

FIG. 5 is an image of the post-formed laminate of Example 4.

### DETAILED DESCRIPTION

Tubing for automotive applications is subject to corrosive forces from the environment and from many automotive fluids. Protective coatings applied to tubing have exhibited only limited resistance to corrosive forces and often exhibit one or more of peeling, creasing, and cracking during metal forming processes. The Applicants surprisingly found that a protective coating that comprises a polyester and an impact modifier results in one or both of an improved chemical resistance and an increased adhesion to automotive tubing. Specifically, the Applicants found that the protective coating can result in changes in percent elongation at a maximum force at break (as measured according to ISO 527) relative to an unsoaked tensile bar of less than or equal to 400 percent (%), specifically, less than or equal to 300%, more specifically, less than or equal to 100%, even more specifically, less than or equal to 50%, still more specifically, less than or equal to 20%, after exposure to a solvent for 500 hours (h) at 23 degrees Celsius (° C.) as determined by GMW3013. These changes in percent elongation and maximum force were maintained following up to 5,000 h exposure at 60° C. as determined by SAEJ2260. The Applicants further found that the protective coating has improved adhesion to automotive tubing such that a 0.010 inch and/or a 0.020 inch nominal gauge film can have an average peel strength of greater than or equal to 0.5 Newtons per millimeter (N/mm), specifically, greater than or equal to 1.0 N/mm, more specifically, greater than or equal to 5.0 N/mm, when peeled at a 90° angle, at a rate of 22 millimeters per minute (mm/min) from a 1 inch wide metal strip, wherein the 1 inch wide metal strip comprises steel and a metal coating, wherein the metal coating comprises 95 wt % zinc and 5 wt % aluminum based upon a total weight of the metal coating.

The protective coating (also referred to as the coating composition) can comprise a polyester, a polycarbonate, a polyarylate, a polyester-carbonate, or a combination comprising at least one of the foregoing; and optionally 1 to 35 wt % (e.g., 1 to 10 wt %) of an impact modifier based on the total weight of the coating composition, excluding any filler. The protective coating can comprise a XENOY™ or VALOX™ resin such as X6800BM, EDXY0397, 1760, 6370, V3004, VIC4311, 325, or X4810 available from SABIC's Innovative Plastics business.

The polyester can be a crystalline polyester. The polyester can contain repeating structural units of formula (1)

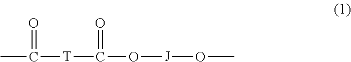

wherein J is a divalent group derived from a dihydroxy compound, specifically, a C₂₋₁₀ alkylene, a C₆₋₂₀ cycloalkylene, or a polyoxyalkylene group in which the alkylene groups contain 2 to 6 carbon atoms, specifically, 2, 3, or 4 carbon atoms; and T is a divalent group derived from a dicarboxylic acid, specifically, a C₂₋₁₀ alkylene, a C₆₋₂₀ cycloalkylene, or a C₆₋₂₀ arylene. Copolyesters containing a combination of different T and/or J groups can be used. The polyesters can be branched or linear.

J can be a C₂₋₃₀ alkylene group having a straight chain, branched chain, or cyclic (including polycyclic) structure. Aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, or a combination comprising at least one of the foregoing acids. Acids containing fused rings can also be present, such as in 1,4-, 1,5-, or 2,6-naphthalenedicarboxylic acids. Specific dicarboxylic acids include terephthalic acid, isophthalic acid, naphthalene dicarboxylic acid, cyclohexane dicarboxylic acid, or a combination comprising at least one of the foregoing acids. A specific dicarboxylic acid comprises a combination of isophthalic acid and terephthalic acid wherein the weight ratio of isophthalic acid to terephthalic acid is 91:9 to 2:98. J can be a C₂₋₆ alkylene group and T can be p-phenylene, m-phenylene, naphthalene, a divalent cycloaliphatic group, or a combination thereof. This class of polyester includes the poly(alkylene terephthalates). Poly(ethylene terephthalate) (“PET”), poly(butylene terephthalate) (“PBT”), and poly(propylene terephthalate) (“PPT”) in particular can be used.

The polyester can comprise PBT, PET, PPT or a combination comprising one or more of the foregoing. The PET can be present in an amount of 0 to 50 weight percent (wt %), specifically, greater than zero to 50 wt %, and more specifically, greater than zero to 30 wt % based on the total amount of PBT, PPT, and PET. The PBT can be present in an amount of 50 to 100 wt %, more specifically, 70 to 100 wt %, and more specifically, 80 to 100 wt %, based on the total amount of PBT, PPT, and PET.

The polyester can have an intrinsic viscosity of 0.4 to 2.0 deciliter per gram (dl/g), or an intrinsic viscosity of 1.1 to 1.4 dl/g, each as measured in a 60:40 phenol/tetrachloroethane mixture or similar solvent at 23-30° C.

The polyester can be present in an amount of 10 wt % to 99 wt %, specifically, 50 wt % to 99 wt %, more specifically, 65 wt % to 99 wt %, based on the total weight of the coating composition, excluding any filler.

The polyester can be used in combination with a polycarbonate, a polyarylate, or a polyester-carbonate.

The polycarbonate can have repeating structural carbonate units of formula (2)

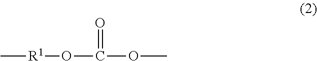

in which at least 60 percent of the total number of R¹ groups contain aromatic moieties and the balance thereof are aliphatic, alicyclic, or aromatic. The polycarbonate can be a homopolycarbonate (wherein each R¹ in the polymer is the same), or a copolycarbonate comprising different R¹ moieties in the carbonate (“copolycarbonate”). The polycarbonate can be straight-chain or branched.

Each R¹ can be a C₆₋₃₀ aromatic group, that is, it can contain at least one aromatic moiety. R¹ can be derived from a dihydroxy compound of the formula HO—R¹—OH, for example of formula (3)

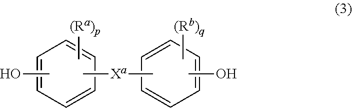

wherein R^{a} and R^{b} are each independently a halogen, C₁₋₁₂ alkoxy, or C₁₋₁₂ alkyl; and p and q are each independently integers of 0 to 4. It will be understood that R^{a} is hydrogen when p is 0, and likewise R^{b} is hydrogen when q is 0. Also in formula (3), X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. Each p and q can be 1, and R^{a} and R^{b} can each be a C₁₋₃ alkyl group, specifically, methyl, disposed meta to the hydroxy group on each arylene group. For example, X^{a} can be a substituted or unsubstituted C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene.

Specific examples of bisphenol compounds of formula (3) include 1,1-bis(4-hydroxyphenyl)methane, 1,1-bis(4-hydroxyphenyl) ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl) n-butane, 2,2-bis(4-hydroxy-2-methylphenyl) propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (PPPBP), and 1,1-bis(4-hydroxy-3-methylphenyl)cyclohexane (DMBPC). Combinations comprising at least one of the foregoing dihydroxy compounds can also be used. The polycarbonate can be a polycarbonate derived from bisphenol A, in which each of A¹ and A² is p-phenylene and Y¹ is isopropylidene in formula (3), specifically, a linear homopolymer of bisphenol A.

All types of polycarbonate end groups are contemplated as being useful provided that such end groups do not significantly adversely affect desired properties of the compositions. Bulky mono phenols, such as cumyl phenol can be used. Branched polycarbonate blocks can be prepared by adding a branching agent during polymerization, for example trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05 to 2.0 wt %. Combinations comprising linear polycarbonates and branched polycarbonates can be used.

The polycarbonate can have an intrinsic viscosity, as determined in chloroform at 25° C., of 0.3 to 1.5 dl/g, specifically, 0.45 to 1.0 dl/g. The polycarbonate can have a weight average molecular weight of 10,000 to 200,000 Daltons, specifically, 20,000 to 100,000 Daltons, as measured by gel permeation chromatography (GPC), using a crosslinked styrene-divinylbenzene column and calibrated to polycarbonate references. GPC samples are prepared at a concentration of 1 mg per ml, and are eluted at a flow rate of 1.5 ml per minute.

The polycarbonate can be present in an amount of 0 to 60 wt %, specifically, greater than 0 to 50 wt %, more specifically, 0.1 to 30 wt %, based on the total weight of the coating composition, excluding any filler. Optionally, the coating composition can be free of polycarbonate and/or free of carbonate units.

The polyarylate can have repeating structural units of formula (1) wherein J is a divalent group derived from an aromatic dihydroxy compound, for example an aromatic dihydroxy compound of formula (3), and T is a divalent group derived from an aromatic dicarboxylic acid, specifically, a C₆₋₂₀ arylene. The polyarylate can be derived from the reaction of a combination of isophthalic acid and terephthalic acid with bisphenol A.

The polyester-carbonate, also known as polyester-polycarbonate, contains both ester units (1) and carbonate units (2). The molar ratio of ester units to carbonate units in the copolymers can vary broadly, for example 1:99 to 99:1, specifically, 10:90 to 90:10, more specifically, 25:75 to 75:25, for example, 75:25 to 99:1 depending on the desired properties of the final composition. The polyester-carbonate can comprise carbonate units derived from bisphenol A and ester units derived from the reaction of a combination of isophthalic acid and terephthalic acid with bisphenol A.

The polyester-carbonate can be present in an amount of up to 99 wt %, specifically, 5 to 99 wt %, more specifically, 10 to 30 wt % based on the total weight of the coating composition, excluding any filler.

The polyester, polycarbonate, polyarylate, and polyester-carbonate can be obtained by interfacial polymerization or melt-process condensation, by solution phase condensation, or by transesterification polymerization wherein, for example, a dialkyl ester such as dimethyl terephthalate can be transesterified with ethylene glycol using acid catalysis, to generate poly(ethylene terephthalate).

The coating composition can further include impact modifier(s). Useful impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

A specific type of impact modifier is an elastomer-modified graft copolymer comprising (i) an elastomeric (i.e., rubbery) polymer substrate having a glass transition temperature (Tg) less than 10° C., more specifically, less than −10° C., or more specifically, −40 to −80° C., and (ii) a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than 50 wt % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers. Materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically, methyl methacrylate.

Specific elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN), and combinations comprising at least one of the foregoing. The impact modifier can comprise one or more of an ABS, MBS, polyethylene (PE), or SEBS that comprise epoxy or maleic anhydride pendent groups.

Other specific impact modifiers are polyolefin copolymers with vinyl epoxide derived units. Such epoxide-functional copolymers can be prepared from an olefin, such as ethylene, and glycidyl acrylate or methacrylate. Other nonfunctionalized vinyl-containing monomers can also be incorporated, such as various C₁₋₄ alkyl acrylates, C₁₋₄ alkyl methacrylates, vinyl esters, and vinyl ethers. A specific impact modifier of this type includes ethylene-alkyl methacrylate-glycidyl methacrylate (EMA-GMA) terpolymers. These epoxy olefin impact modifiers can be used in an amount 1 to 35 wt %, based on the total weight of the polymers in the composition.

The impact modifier can comprise a polyester-polyether elastomer.

Likewise, the impact modifier can comprise an epoxy containing acrylic impact modifier that can optionally comprise styrene repeat units. The epoxy containing acrylic impact modifier can have an epoxide equivalent molecular weight of 100 to 20,000 grams per mole (g/mol), specifically, 5,000 to 20,000 g/mol. The epoxy containing acrylic impact modifier can be used in an amount of 0.1 to 35 wt %, based on the total weight of the polymers in the composition.

The impact modifier can be present in an amount of 1 to 35 wt %, specifically, 5 to 35 wt %, more specifically, 5 to 30 wt %, based on the total weight of the polymers in the composition. The impact modifier can be present in an amount of 1 to 30 wt %, based on the total weight of the polymers in the coating composition.

In addition to the above components and any impact modifier, the compositions can include various additives ordinarily incorporated into polymer compositions of this type, with the proviso that the additive(s) are selected so as to not significantly adversely affect the desired properties of the thermoplastic composition, in particular the chemical resistance. Such additives can be mixed at a suitable time during the mixing of the components for forming the composition. Additives include, fillers, reinforcing agents, antioxidants, heat stabilizers, light stabilizers, ultraviolet (UV) light stabilizers, plasticizers, lubricants, mold release agents, antistatic agents, colorants (such as such as titanium dioxide, carbon black, and organic dyes), surface effect additives, radiation stabilizers, flame retardants, and anti-drip agents. Possible additives can be an epoxy-containing impact modifier (e.g., epoxy-containing reactive impact modifier). A combination of additives can be used, for example a combination of a heat stabilizer, mold release agent, and ultraviolet light stabilizer. In general, the additives are used in the amounts generally known to be effective. The total amount of additives (other than any impact modifier, filler, or reinforcing agents) is generally 0.01 to 5 wt %, based on the total weight of the coating composition.

The coating composition can comprise a filler. Possible fillers or reinforcing agents include, for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well combinations comprising at least one of the foregoing fillers or reinforcing agents. The fillers and reinforcing agents can be coated with a layer of metallic material to facilitate conductivity, or surface treated with silanes to improve adhesion and dispersion with the polymeric matrix resin. Fillers are used in amounts of 1 to 50 parts by weight (pbw), based on 100 parts by weight of the polymers in the coating composition.

Antioxidant additives include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)]methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or combinations comprising at least one of the foregoing antioxidants. Antioxidants are used in amounts of 0.01 to 0.1 parts by weight, based on 100 parts by weight of the total composition, excluding any filler.

Heat stabilizer additives include organophosphites such as triphenyl phosphite, tris-(2,6-dimethylphenyl)phosphite, tris-(mixed mono-and di-nonylphenyl)phosphite; phosphonates such as dimethylbenzene phosphonate, phosphates such as trimethyl phosphate, or combinations comprising at least one of the foregoing heat stabilizers. Heat stabilizers are used in amounts of 0.01 to 0.1 parts by weight, based on 100 parts by weight of the total composition, excluding any filler.

Light stabilizers and/or ultraviolet light (UV) absorbing additives can also be used. Light stabilizer additives include benzotriazoles such as 2-(2-hydroxy-5-methylphenyl)benzotriazole, 2-(2-hydroxy-5-tert-octylphenyl)-benzotriazole, and 2-hydroxy-4-n-octoxy benzophenone, or combinations comprising at least one of the foregoing light stabilizers. Light stabilizers are used in amounts of 0.01 to 5 parts by weight, based on 100 parts by weight of the total composition, excluding any filler.

UV absorbing additives include hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-]4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3, 3-diphenylacryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than or equal to 100 nanometers; or combinations comprising at least one of the foregoing UV absorbers. UV absorbers are used in amounts of 0.01 to 5 parts by weight, based on 100 parts by weight of the total composition, excluding any filler.

Plasticizers, lubricants, and/or mold release agents can also be used. There is considerable overlap among these types of materials, which include phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate, and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a solvent; waxes such as beeswax, montan wax, and paraffin wax. Such materials are used in amounts of 0.1 to 1 parts by weight, based on 100 parts by weight of the total composition, excluding any filler.

Useful flame retardants include organic compounds that include phosphorus, bromine, and/or chlorine. Non-brominated and non-chlorinated phosphorus-containing flame retardants can be preferred in certain applications for regulatory reasons, for example organic phosphates and organic compounds containing phosphorus-nitrogen bonds.

Flame retardant aromatic phosphates include triphenyl phosphate, tricresyl phosphate, isopropylated triphenyl phosphate, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, and 2-ethylhexyl diphenyl phosphate. Di- or polyfunctional aromatic phosphorus-containing compounds are also useful, for example resorcinol tetraphenyl diphosphate (RDP), the bis(diphenyl) phosphate of hydroquinone and the bis(diphenyl) phosphate of bisphenol A, respectively, and their oligomeric and polymeric counterparts. Flame retardant compounds containing phosphorus-nitrogen bonds include phosphonitrilic chloride, phosphorus ester amides, phosphoric acid amides, phosphonic acid amides, phosphinic acid amides, and tris(aziridinyl) phosphine oxide. When used, phosphorus-containing flame retardants are present in amounts of 0.1 to 30 parts by weight, more specifically, 1 to 20 parts by weight, based on 100 parts by weight of the total composition, excluding any filler.

Halogenated materials can also be used as flame retardants, for example bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; and 2,2-bis-(3,5-dichloro-4-hydroxyphenyl)-propane 2,2 bis-(3-bromo-4-hydroxyphenyl)-propane. Other halogenated materials include 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, as well as oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant. When present, halogen containing flame retardants are present in amounts of 1 to 25 parts by weight, more specifically, 2 to 20 parts by weight, based on 100 parts by weight of the total composition, excluding any filler.

Alternatively, the compositions can be essentially free of chlorine and bromine. “Essentially free of chlorine and bromine” is defined as having a bromine and/or chlorine content of less than or equal to 100 parts per million (ppm), less than or equal to 75 ppm, or less than or equal to 50 ppm, based on the total parts by weight of the composition, excluding any filler.

Inorganic flame retardants can also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate; salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, and/or Na₃AlF₆. When present, inorganic flame retardant salts are present in amounts of 0.01 to 10 parts by weight, more specifically, 0.02 to 1 parts by weight, based on 100 parts by weight of the total composition, excluding any filler.

Anti-drip agents can also be used in the composition, for example a fibril forming or non-fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. A TSAN comprises 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Antidrip agents can be used in amounts of 0.1 to 10 parts by weight, based on 100 parts by weight of the total composition, excluding any filler.

The compositions can be manufactured by various methods. For example, the polymers and other optional components are first blended, optionally with fillers in a HENSCHEL-Mixer™ high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

The compositions have excellent physical properties, including: a melt volume ratio (MVR) of 5 to 40, more specifically, 5 to 30 centimeters cubed (cm³)/10 minutes, measured at 250° C. under a load of 5 kilograms (kg) and/or 265° C. under a load of 5 kg in accordance with ISO 1183.

The compositions can further have a heat deflection temperature (HDT) of 40 to 220° C., more specifically, 40 to 150° C., measured at 1.82 megaPascal (MPa) according to ASTM D648.

The compositions can further have a Notched Izod Impact (NII) of 100 to 1,000 feet-pounds (ft-lb) per inch, measured at 23° C. using 1/8-inch thick bars (3.18 millimeters (mm)) in accordance with ASTM D256.

The coating composition can be resistant to chemicals commonly used as automotive fluids. For example, the coated tube can be resistant to one or more of the following solvents: battery acid, biodiesel, brake fluid, 50 wt % calcium chloride, diesel #2, E-22 (mixture of 22 volume percent (vol %) anhydrous ethanol and 78 vol % gasoline), E-85 (mixture of 85 vol % anhydrous ethanol and 15 vol % gasoline), low pH, (ethanol with an acidity (pH) of 6.5-9.0, engine coolant, oxidized gasoline, 50 wt % sodium chloride, TF-2 (GM Test Fuel 2, an ethanol/methanol blend), water, 50 wt % zinc chloride, CE-10 (10 vol % ethanol and 90 vol % 50/50 (volume ratio) iso-octane/toluene), CM-15 (15 vol % methanol and 85 vol % 50/50 (volume ratio) iso-octane/toluene) such that tensile bars formed from the coating composition can result in a change in percent elongation relative to an unsoaked tensile bar of less than or equal to 400%, specifically, less than or equal to 300%, more specifically, less than or equal to 100%, even more specifically, less than or equal to 50%, still more specifically, less than or equal to 20% after exposure to the solvent for 500 h at 23° C. as determined by GMW3013, and can even maintain these changes in percent elongation after exposure to the solvent for 1,000 h at 60° C. as determined by SAEJ2260.

The coating composition can have improved adhesion to automotive tubing such that a 0.010 inch and/or a 0.020 inch nominal gauge film can have an average peel strength of greater than or equal to 0.5 N/mm, specifically, greater than or equal to 1.0 N/mm, specifically, greater than or equal to 3.0 N/mm, more specifically, greater than or equal to 5.0 N/mm, when peeled at a 90° angle and at a rate of 25 mm/min. As used herein, unless specified otherwise, the peel test was performed at a 90° angle and at a rate of 22 mm/min on a 1 inch wide metal strip, wherein the metal strip comprises steel and a metal coating, wherein the metal coating comprises 95 wt % zinc and 5 wt % aluminum based upon a total weight of the metal coating.

The tube can comprise a metal or a polymer. The tube can optionally be rigid or semi-rigid. When the tube comprises metal, the metal can comprise steel such as a welded steel or a brazed steel. The metal can comprise stainless steel. The metal can comprise iron, aluminum, zinc, chromium, manganese, vanadium, tungsten, zinc, or a combination comprising one or more of the foregoing. The metal can comprise a zinc-aluminum galvanizing alloy that comprises 85 wt % to 97 wt % zinc, 4 wt % to 15 wt % aluminum, and optionally at least 5 ppm mischmetal (a variety of known rare earth containing alloys) based on the total amount of zinc and aluminum.

When the tube comprises a polymer, the polymer can comprise poly(vinyl chloride), polyethylene (such as low density polyethylene, high density polyethylene, or ultra high molecular weight polyethylene), acrylonitrile-butadiene-styrene copolymer, polybutylene, polypropylene, poly(vinylidene fluoride), polyamide, polysiloxane, nylon, or a combination comprising one or more of the foregoing. The polymer tube can be a reinforced polymer tube that is reinforced with for example steel wires, aramid fibers, polyester fibers, glass fibers, carbon fibers, mineral filler, or a combination comprising one or more of the foregoing.

The protective coating can be applied to one or both of the inside and outside of the tube to result in a coated tube. The protective coating can be applied by methods such as co-extrusion, dip coating, spray coating, and so forth Likewise, the protective coating can be applied by first heating the tube to a temperature above the melting point of the protective coating. The protective coating can then either be applied to the outside of the tube by rolling the heated tube in the protective coating and/or to the inside of the tube by introducing protective coating composition to the inside of the tube, with for example hot air, and rotating the tube. The temperature of the tube can then be lowered such that it is below the melting point of the protective coating.

The protective coating can have a coating thickness of up to several millimeters (e.g., up to or exceeding 10 millimeters (mm)), specifically, 0.01 to 5 mm, more specifically, 0.05 to 2 mm, and more specifically, 0.1 to 0.5 mm.

The coated tube can further comprise various other layers, such as a metal coating layer or an adhesive layer. One or more of said layers can be located in between the tube and the protective coating.

The tube can be coated with a metal layer. The metal layer can comprise zinc, aluminum, nickel, cobalt, or a combination comprising one or more of the foregoing, such as a zinc alloy. An example of a possible zinc alloy can comprise 90 to 98 wt % zinc and 2 to 10 wt % aluminum, specifically, 95 wt % zinc and 5 wt % aluminum. The metal layer can comprise a first layer of zinc that can be 0.4 mil (0.010 mm) to 1.0 mil (0.025 mm) in thickness and a second layer of a zinc-aluminum alloy such as that available under the trade name GALFAN™ (from Galfan Technology Centre, Inc.) that can have a coating density of 35 to 95 grams per meter squared (g/m²). For example, the tube can be a stainless steel tube with a metal layer comprising a zinc-aluminum alloy.

An adhesive layer can be used to further increase the adhesion between the protective coating and the tube. The adhesive layer can comprise a polyurethane, a polyimide, a polyacrylate, a cyanoacrylate, an epoxy, or a combination comprising one or more of the foregoing.

The coated tube can further comprise a phosphate layer, for example, located between a metal layer and an adhesive layer.

The coated tube can be postformed by subjecting it to a shaping process such as one or more of bending, pressing, and the like. For example the coated tube can be subjected to bending by a programmable power bender.

The coated tube can withstand temperatures of −40 to 115° C., specifically, −30 to 50° C.

The protective coating can be used to coat components in transportation vehicles such as airplanes, trains, automobiles, motorcycles, scooters, buses, and cable cars. The coating can be used to coat components such as a Bowden cable sheath, a door lock casing, a polymer optical fiber sheath, a windshield washer line, a windshield wiper bearing, a coupling (such as one for coupling fuel lines), and the like. The protective coating can be used to coat a tube such as one used as a vacuum line (such as a vacuum line for power brakes), a coolant line, a compressed air suspension line, a fuel line, a brake line, a hydraulic clutch line, and the like. A tube coated with the protective coating can be used for conveying hydraulic fluids (such as for brakes, clutches, transmissions, power steering, fans, and the like), fuels (such as methanol, ethanol, gasoline, additives, diesel, kerosene, jet fuel, and mixtures thereof), vapor, and the like.

Set forth below are some embodiments of a coated tube and methods for making the coated tube.

Embodiment 1: A coated tube comprises: a tube and a coating composition on the tube. The coating composition comprises a polyester and an impact modifier, and wherein the impact modifier comprises at least one pendent group selected from epoxy groups and maleic anhydride groups.

Embodiment 2: A coated tube comprising: a tube and a coating composition on the tube. The coating composition comprises a polyester and an impact modifier, and wherein the polyester comprises poly(butylene terephthalate).

Embodiment 3: The coated tube of Embodiment 2, wherein the impact modifier comprises at least one pendent group selected from epoxy groups and maleic anhydride groups.

Embodiment 4: The coated tube of any of Embodiments 2-3, wherein the polyester further comprises one or more of, poly(ethylene terephthalate), and poly(propylene terephthalate).

Embodiment 5: The coated tube of any of Embodiments 1-4, wherein the polyester comprises 50 to 100 wt % poly(butylene terephthalate), based on the total amount of the polyester.

Embodiment 6: The coated tube of any of Embodiments 1-5, wherein the polyester comprises 70 to 100 wt % poly(butylene terephthalate), based on the total amount of the polyester.

Embodiment 7: The coated tube of any of Embodiments 1-6, wherein impact modifier is present in an amount of 1 to 35 wt %, based upon a total weight of the coating composition.

Embodiment 8: The coated tube of any of Embodiments 1-7, wherein the coating composition comprises 65 to 95 wt % of polyester and 5 to 35 wt % of the impact modifier, based upon a total weight of the coating composition.

Embodiment 9: The coated tube of any of Embodiments 1-8, wherein the coating composition comprises 65 to 75 wt % of polyester and 25 to 35 wt % of the impact modifier.

Embodiment 10: The coated tube of any of Embodiments 1-9, wherein the coating composition further comprises a polycarbonate, a polyarylate, a polyester-carbonate resin, or a combination comprising one or more of the foregoing.

Embodiment 11: The coated tube of any of Embodiments 1-10, wherein the coating composition is free of carbonate units.

Embodiment 12: The coated tube of any of Embodiments 1-11, wherein the impact modifier is at least one of acrylic rubber and polyolefin copolymers.

Embodiment 13: The coated tube of any of Embodiments 1-12, wherein the impact modifier comprises a polyolefin copolymer comprising a unit derived from at least one of acrylic, vinyl ester, and vinyl ether.

Embodiment 14: The coated tube of Embodiment 13, wherein the unit comprises a methacrylic unit.

Embodiment 15: The coated tube of any of Embodiments 1-14, wherein the impact modifier comprises methacrylate butadiene rubber.

Embodiment 16: The coated tube of any of Embodiments 1, and 3-15, wherein the pendent group comprises the epoxy group.

Embodiment 17: The coated tube of any of Embodiments 1-16, wherein impact modifier is an epoxy containing acrylic impact modifier.

Embodiment 18: The coated tube of any of Embodiments 16-17, wherein impact modifier comprises one or more of ABS, MBS, polyethylene, and SEBS.

Embodiment 19: The coated tube of any of Embodiments 16-19, wherein the impact modifier has an epoxide equivalent molecular weight of 100 to 20,000 g/mol.

Embodiment 20: The coated tube of Embodiment 19, wherein the epoxide equivalent molecular weight is 5,000 to 20,000 g/mol.

Embodiment 21: The coated tube of any of Embodiments 1-20, wherein a 4 mm thick tensile bar made from the coating composition soaked in a solvent comprising one or more of battery acid, biodiesel, brake fluid, calcium chloride, diesel #2, E-22, E-85 low pH_{c}, engine coolant, oxidized gasoline, sodium chloride, TF-2, water, zinc chloride, CE-10, or CM-15 results in a change in percent elongation relative to an unsoaked tensile bar of less than or equal to 400 percent after exposure to the solvent for 500 hours at 23° C. as determined by GMW3013.

Embodiment 22: The coated tube of any of Embodiments 1-21, wherein a 4 mm thick tensile bar made from the coating composition soaked in a solvent comprising one or more of battery acid, biodiesel, brake fluid, calcium chloride, diesel #2, E-22, E-85 low pHₑ, engine coolant, oxidized gasoline, sodium chloride, TF-2, water, zinc chloride, CE-10, or CM-15 results in a change in percent elongation relative to an unsoaked tensile bar of less than or equal to 100 percent after exposure to the solvent for 500 hours at 23° C. as determined by GMW3013.

Embodiment 23: The coated tube of any of Embodiments 1-22, wherein a 0.254 mm nominal gauge film of the coating composition has an average peel strength from a 1 inch wide metal strip of greater than or equal to 0.5 N/mm when peeled at a 90° angle, wherein the 1 inch wide metal strip comprises steel and a metal coating, wherein the metal coating comprises 95 wt % zinc and 5 wt % aluminum based upon a total weight of the metal coating.

Embodiment 24: The coated tube of any of Embodiments 1-23, wherein a 0.508 mm nominal gauge film of the coating composition has an average peel strength from a 1 inch wide metal strip of greater than or equal to 0.5 N/mm when peeled at a 90° angle, wherein the 1 inch wide metal strip comprises steel and a metal coating, wherein the metal coating comprises 95 wt % zinc and 5 wt % aluminum based upon a total weight of the metal coating.

Embodiment 25: The coated tube of any of Embodiments 1-24, wherein a 0.508 mm nominal gauge film of the coating composition has an average peel strength from a 1 inch wide metal strip of greater than or equal to 1.0 N/mm when peeled at a 90° angle, wherein the 1 inch wide metal strip comprises steel and a metal coating, wherein the metal coating comprises 95 wt % zinc and 5 wt % aluminum based upon a total weight of the metal coating.

Embodiment 26: The coated tube of any of Embodiments 1-25, wherein a 0.508 mm nominal gauge film of the coating composition has an average peel strength from a 1 inch wide metal strip of greater than or equal to 5.0 N/mm when peeled at a 90° angle, wherein the 1 inch wide metal strip comprises steel and a metal coating, wherein the metal coating comprises 95 wt % zinc and 5 wt % aluminum based upon a total weight of the metal coating.

Embodiment 27: The coated tube of any of Embodiments 1-26, wherein the coated tube further comprises one or more of a metal coating layer, a phosphate layer, and an adhesion layer.

Embodiment 28: The coated tube of Embodiment 1-27, wherein the coated tube comprises the metal coating and wherein the metal coating comprises greater than or equal to 70 wt % zinc, based upon a total weight of the metal coating.

Embodiment 29: The coated tube of Embodiment 27 or 28, wherein the metal coating is located between the coating composition and the tube, wherein the metal coating comprises greater than or equal to 70 wt % zinc, based upon a total weight of the metal coating.

Embodiment 30: The coated tube of any of Embodiments 27-29, wherein the metal coating comprises greater than or equal to 90 wt % zinc, based upon a total weight of the metal coating.

Embodiment 31: The coated tube of any of Embodiments 27-30, wherein the metal coating layer comprises zinc, aluminum, nickel, cobalt, or a combination comprising one or more of the foregoing.

Embodiment 32: The coated tube of any of Embodiments 27-31, wherein the metal layer comprises a first metal layer comprising steel, wherein the first metal layer is 0.4 mil (0.010 mm) to 1.0 mil (0.025 mm) in thickness and the metal coating, wherein the metal coating comprises a zinc-aluminum alloy, wherein the metal coating has a coating density of 35 to 95 grams per meter squared (g/m²).

Embodiment 33: The coated tube of any of Embodiments 27-32, wherein the adhesive layer comprises a polyurethane, a polyimide, a polyacrylate, a cyanoacrylate, an epoxy, or a combination comprising one or more of the foregoing.

Embodiment 34: The coated tube of any of Embodiments 27-33, wherein the phosphate layer is located between the metal layer and the adhesive layer.

Embodiment 35: The coated tube of any of Embodiments 1-34, wherein a 4 mm thick tensile bar made from the coating composition soaked in a solvent comprising one or more of battery acid, biodiesel, brake fluid, calcium chloride, diesel #2, E-22, E-85 low pHₑ, engine coolant, oxidized gasoline, sodium chloride, TF-2, water, zinc chloride, CE-10, or CM-15 results in a change in percent elongation relative to an unsoaked tensile bar of less than or equal to 400 percent after exposure to the solvent for 1,000 h and/or for 5,000 h at 60° C. as determined by SAEJ2260.

Embodiment 36: The coated tube of any of Embodiments 1-35, wherein a 4 mm thick tensile bar made from the coating composition soaked in a solvent comprising one or more of battery acid, biodiesel, brake fluid, calcium chloride, diesel #2, E-22, E-85 low pHₑ, engine coolant, oxidized gasoline, sodium chloride, TF-2, water, zinc chloride, CE-10, or CM-15 results in a change in percent elongation relative to an unsoaked tensile bar of less than or equal to 100 percent after exposure to the solvent for 1,000 h and/or for 5,000 h at 60° C. as determined by SAEJ2260.

Embodiment 37: The coated tube of any of Embodiments 1-36, wherein the coating composition comprises: 20-100 wt % PBT, 0-30 wt % polycarbonate, and 0-50 wt % PET, wherein the weight percentages are based upon a total weight of polymer in the coating composition.

Embodiment 38: The coated tube of any of Embodiments 1-37, wherein the coating composition comprises: 20-100 wt % PBT, greater than 0 to 30 wt % polycarbonate, and 0-50 wt % PET, wherein the weight percentages are based upon a total weight of polymer in the coating composition.

Embodiment 39: The coated tube of any of Embodiments 1-38, wherein the coating composition comprises: 20-100 wt % PBT, 0-30 wt % polycarbonate, and greater than 0 to 50 wt % PET, wherein the weight percentages are based upon a total weight of polymer in the coating composition.

Embodiment 40: The coated tube of any of Embodiments 37-39, wherein the coating composition comprises: 20-100 wt % PBT; and 1-30 wt % polycarbonate and/or 1-50 wt % PET, wherein the weight percentages are based upon a total weight of polymer in the coating composition.

Embodiment 41: The coated tube of any of Embodiments 1-40, wherein the coating composition comprises greater than or equal to 95 wt % PBT, wherein the weight percentages are based upon a total weight of polymer in the coating composition.

Embodiment 42: The coated tube of any of Embodiments 1-41, wherein the polyester comprises a crystalline polyester.

Embodiment 43: A method of coating a tube comprising: applying a coating composition to a tube. The coating composition comprises a polyester and an impact modifier, and wherein the impact modifier comprises at least one pendent group selected from epoxy groups and maleic anhydride groups; or the coating composition comprises a polyester and an impact modifier, and wherein the polyester comprises poly(butylene terephthalate); or the coating composition comprises a polyester and an impact modifier, and wherein the polyester comprises poly(butylene terephthalate) and the impact modifier comprises at least one pendent group selected from epoxy groups and maleic anhydride groups.

Embodiment 44: The method of Embodiment 43, wherein the coating composition comprises the coating composition as set forth in any of Embodiments 1-42.

The coating compositions are further illustrated by the following non-limiting examples.

### EXAMPLES

### Example 1

### Solvent Resistance of XENOY™ EDXY0397

A XENOY™ EDXY0397 coating composition comprising 68 wt % poly(butylene terephthalate) and 25 wt % of an ABS impact modifier (balance common additives) was tested for chemical resistance to various solvents according to General Motors Worldwide Engineering Standards (GMW) 3013 by exposing the coating composition to a chemical for 500 hours at 23° C. Specifically, 4 mm thick tensile bars (ISO 527) were prepared with the conditions for injection molding according to ISO294 (as specified in X6800BM data sheet). The percent elongation and maximum force at break were measured after the exposure period, where higher elongation corresponds to softening from solvent penetration and therefore less chemical resistance.

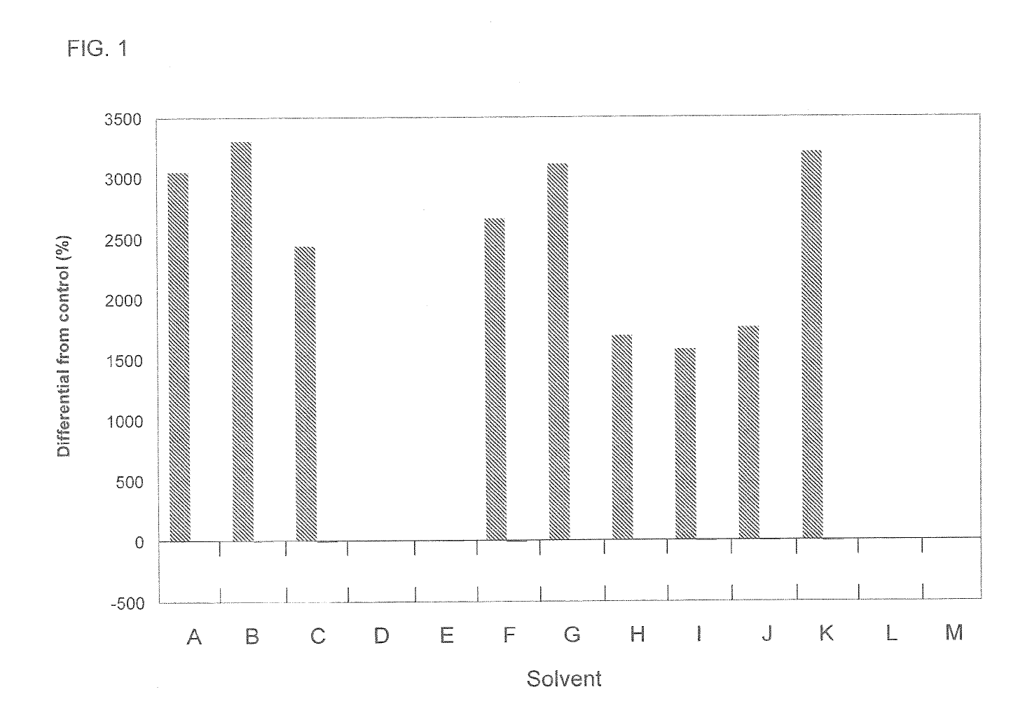

The percent elongation (dashed bars) and maximum force (solid bars) of tensile bars were determined based on exposure to thirteen different solvents A-M and was compared to the percent elongation of a tensile bar that was not exposed to a solvent. The solvents tested were battery acid (A), biodiesel (B), brake fluid (C), calcium chloride (D), diesel #2 (E), E-22 (F), E-85 low pHₑ (G), engine coolant (H), oxidized gasoline (I), sodium chloride (J), TF-2 (K), water (L), and zinc chloride (M). The results are shown in FIG. 1.

The results in FIG. 1 show that most of the solvents tested resulted in an increase in the percent elongation relative to the test bar that was not exposed to solvent of 1,500 to greater than 3,000 percent. The XENOY™ EDXY0397 coating composition comprising the ABS impact modifier therefore displayed poor chemical resistance to all of the solvents of battery acid, biodiesel, brake fluid, E-22, E-85 low pHₑ, engine coolant, oxidized gasoline, sodium chloride, and TF-2.

### Example 2

### Solvent Resistance of XENOY™ X6800BM

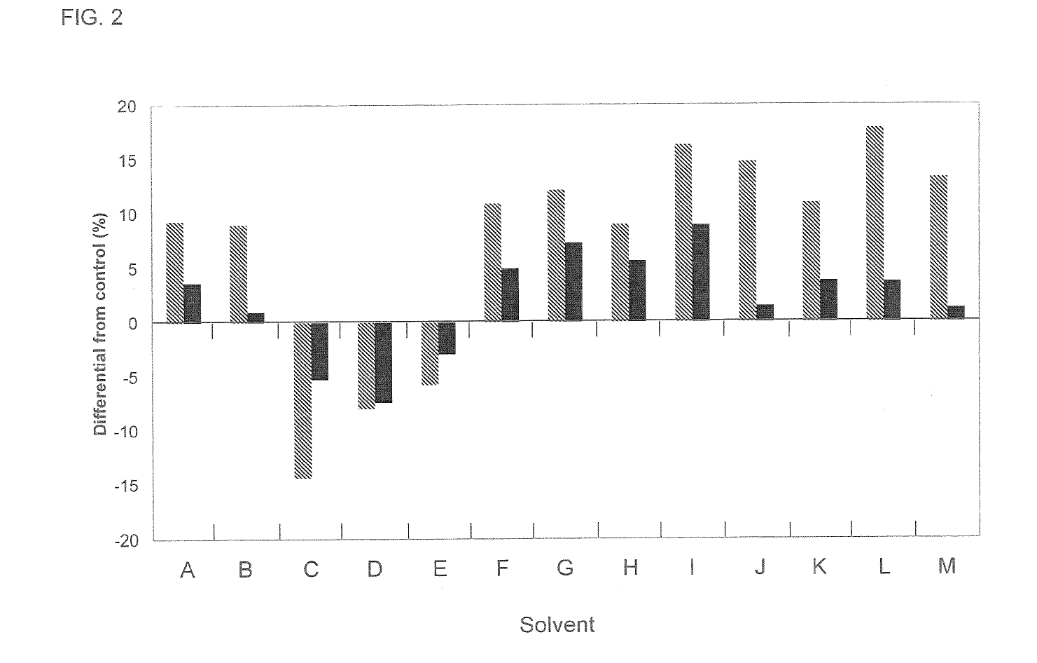

As in Example 1, a XENOY™ X6800BM coating compositions comprising 78 wt % poly(butylene terephthalate) and 20 wt % of an epoxy-containing acrylic impact modifier (balance being common additives), was tested for chemical resistance to various solvents according to GMW3013 by exposing the coating composition to a chemical for 500 hours at 23° C. Specifically, the percent elongation and maximum force of X6800BM tensile bars after exposure to thirteen different solvents A-M and was compared to the percent elongation of a tensile bar that was not exposed to a solvent. The solvents tested were battery acid (A), biodiesel (B), brake fluid (C), calcium chloride (D), diesel #2 (E), E-22 (F), E-85 low pHₑ (G), engine coolant (H), oxidized gasoline (I), sodium chloride (J), TF-2 (K), water (L), and zinc chloride (M). The percent elongation (dashed bars) and maximum force (solid bars) are shown in FIG. 2.

The results in FIG. 2 surprisingly show that all of the solvents tested resulted in little to no change in the percent elongation relative to the tensile bar that was not exposed to solvent, of less than or equal to 15. The XENOY™ X6800BM coating composition containing the epoxy containing acrylic impact modifier therefore displayed excellent chemical resistance.

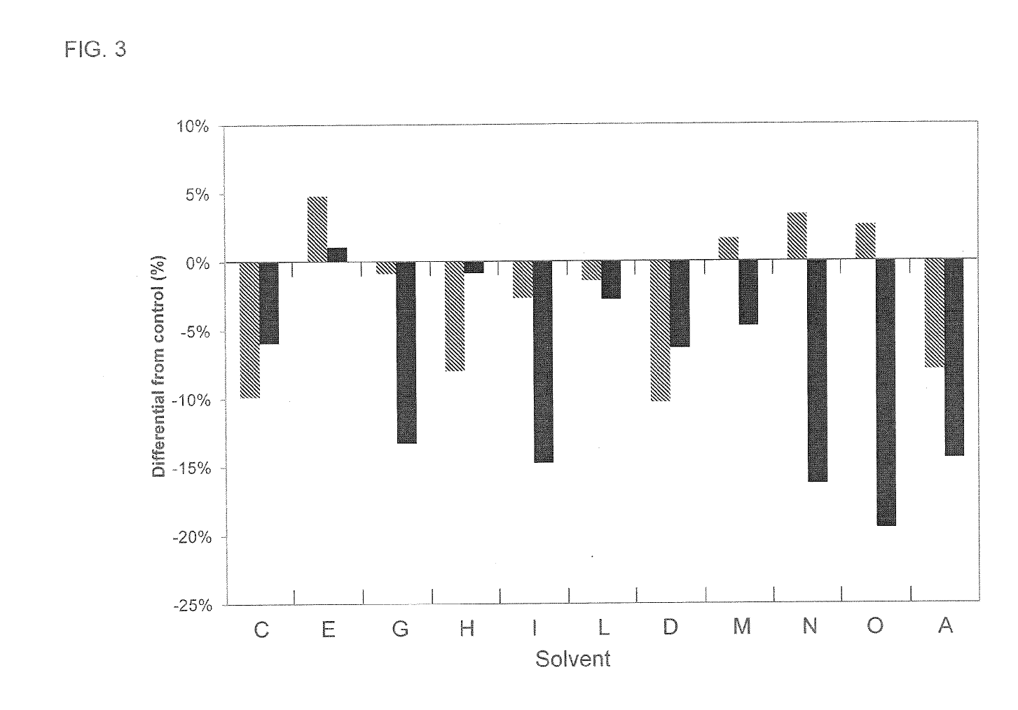

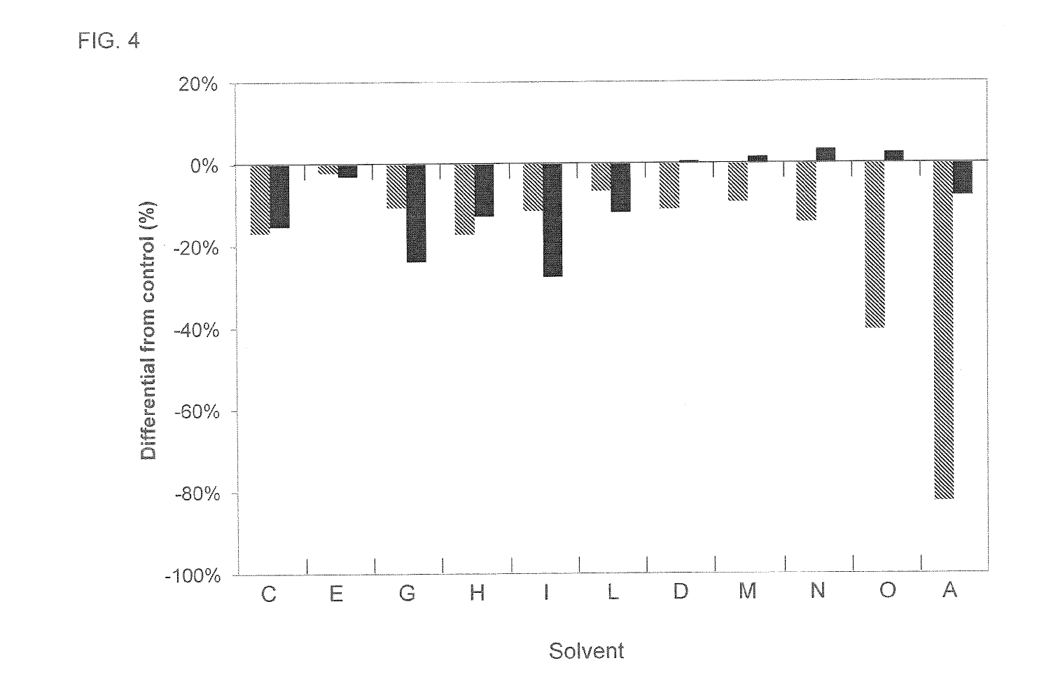

FIG. 2 also shows the percent elongation and force differential (determined from the control (the unexposed tensile bar) after exposure to various solvents for 500 hours at 23° C. FIG. 3 is a graphical representation of the percent elongation (dashed bars) and maximum force (solid bars) (determined from the control (the unexposed tensile bar) after exposure to various solvents 60° C. for 1,000 h, where the solvent (N) is CE-10 (10 vol % ethanol and 90 vol % 50/50 (volume ratio) iso-octane/toluene) and the solvent (O) is CM-15 (15 vol % methanol and 85 vol % 50/50 (volume ratio) iso-octane/toluene). FIG. 4 is a graphical representation of the percent elongation (dashed bars) and maximum force (solid bars) (determined from the control (the unexposed tensile bar) after exposure to various solvents 60° C. for 5,000 h.

### Example 3

### Adhesion Testing of XENOY

XENOY™ X6800BM was extruded into a film (0.010 inch and 0.020 inch nominal gauge films) and laminated onto flat GALFAN™ treated steel panels in a 250° C. vacuum lamination process, where the thickness of the GALFAN™ layer was 0.046 inches. The laminated panels were cut into 1 inch (25 millimeter (mm)) wide strips and were subjected to a 90° peel test. Specifically, the laminated sample was inserted into a five roll fixture where the XENOY™ X6800BM film is peeled off of the GALFAN™ surface at a 90° angle in at a controlled rate. The average peel strength was determined to be 1.36 Newtons per millimeter (N/mm) with a scatter of 0.18 N/mm.

### Example 4

### Postforming a Laminate

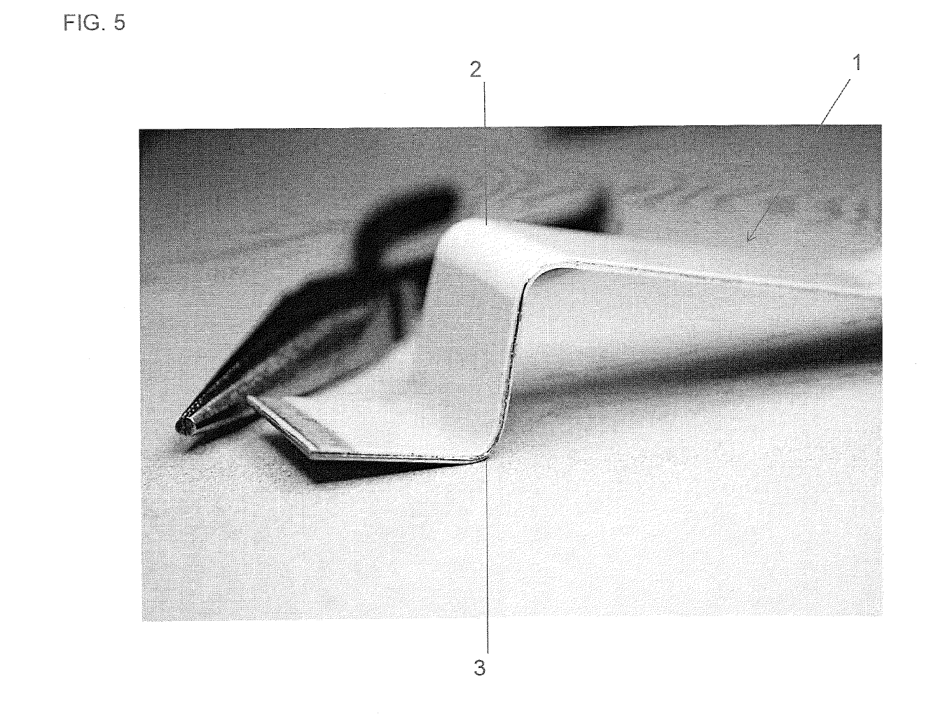

A laminated panel as described in Example 3, that was not subjected to a 90° peel test was subjected to postforming processing. Specifically, the laminated panel was bent into 90° angles. The postformed sample 1 can be seen in FIG. 5. FIG. 5 shows that the postformed laminated sample did not result in any cracking or delamination in either the outer bend 2 or the inner bend 3. These results are especially surprising as delamination in the inner bend 3 generally creates strong normal forces that promote delamination. Some stress whitening was observed in outer bend 2.

In general, the coating composition can alternately comprise, consist of, or consist essentially of, any appropriate components herein disclosed. The coating composition can additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films).

While particular embodiments have been described, alternatives, modifications, variations, improvements, and substantial equivalents that are or can be presently unforeseen may arise to applicants or others skilled in the art. Accordingly, the appended claims as filed and as they can be amended are intended to embrace all such alternatives, modifications variations, improvements, and substantial equivalents.

I/We claim:

1. A coated tube comprising:
a tube; and
a coating composition on the tube, wherein the coating composition comprises a polyester and an impact modifier, and wherein the impact modifier comprises at least one pendent group selected from epoxy groups and maleic anhydride groups.

2. The coated tube of claim 1, wherein the polyester comprises 50 to 100 wt % poly(butylene terephthalate), based on the total amount of the polyester.

3. (canceled)

4. The coated tube of claim 1, wherein impact modifier is present in an amount of 1 to 35 wt %, based upon a total weight of the coating composition.

5. The coated tube of claim 1, wherein the coating composition comprises 65 to 95 wt % of polyester and 5 to 35 wt % of the impact modifier, based upon a total weight of the coating composition.

6. The coated tube of claim 1, wherein the coating composition further comprises a polycarbonate, a polyarylate, a polyester-carbonate resin, or a combination comprising one or more of the foregoing.

7. The coated tube of claim 1, wherein the coating composition is free of carbonate units.

8. The coated tube of claim 1, wherein the impact modifier is at least one of acrylic rubber and polyolefin copolymers.

9. The coated tube of claim 1, wherein the impact modifier comprises a polyolefin copolymer comprising a unit derived from at least one of acrylic, vinyl ester, and vinyl ether.

10. The coated tube of claim 1, wherein the impact modifier comprises methacrylate butadiene rubber.

11. The coated tube of claim 1, wherein the pendent group comprises the epoxy group.

12. The coated tube of claim 1, wherein impact modifier is an epoxy containing acrylic impact modifier.

13. The coated tube of claim 1, wherein impact modifier comprises one or more of acrylonitrile-butadiene-styrene, methyl methacrylate-butadiene-styrene, polyethylene, and styrene-ethylene-butadiene-styrene.

14. The coated tube of claim 1, wherein the impact modifier has an epoxide equivalent molecular weight of 100 to 20,000 g/mol.

15. The coated tube of claim 1, wherein a 4 mm thick tensile bar (ISO 527) made from the coating composition soaked in a solvent comprising one or more of battery acid, biodiesel, brake fluid, calcium chloride, diesel #2, E-22, E-85 low pHₑ, engine coolant, oxidized gasoline, sodium chloride, TF-2, water, zinc chloride, CE-10, and CM-15 results in a change in percent elongation relative to an unsoaked test bar of less than or equal to 400 times after exposure to a solvent for 500 hours at 23° C. as determined by GMW3013.

16. The coated tube of claim 1, wherein a 0.254 mm nominal gauge film of the coating composition has an average peel strength from a 1 inch wide metal strip of greater than or equal to 0.5 N/mm when peeled at a 90° angle and/or wherein a 0.508 mm nominal gauge film of the coating composition has an average peel strength from a 1 inch wide metal strip of greater than or equal to 0.5 N/mm when peeled at a 90° angle, wherein the 1 inch wide metal strip comprises steel and a metal coating, wherein the metal coating comprises 95 wt % zinc and 5 wt % aluminum based upon a total weight of the metal coating.

17. The coated tube of claim 1, wherein the tube comprises steel.

18. The coated tube of claim 1, further comprising a metal coating between the coating composition and the tube, wherein the metal coating comprises greater than or equal to 70 wt % zinc, based upon a total weight of the metal coating.

19. The coated tube of claim 1, wherein the coating composition comprises 20-100 wt % poly(butylene terephthalate);
0-30 wt % polycarbonate; and
0-50 wt % poly(ethylene terephthalate);
wherein the weight percentages are based upon a total weight of resin in the coating composition.

20. The coated tube of claim 1, wherein the polyester comprises poly(butylene terephthalate).

21. A method of coating a tube comprising:
applying a coating composition to a tube;
wherein
the coating composition comprises a polyester and an impact modifier, and wherein the impact modifier comprises at least one pendent group selected from epoxy groups and maleic anhydride groups; or
the coating composition comprises a polyester and an impact modifier, and wherein the polyester comprises poly(butylene terephthalate); or
the coating composition comprises a polyester and an impact modifier, and wherein the polyester comprises poly(butylene terephthalate) and the impact modifier comprises at least one pendent group selected from epoxy groups and maleic anhydride groups.
